(19) United States
(12) Patent Application Publication
(10) Pub. No.: US 2026/0339625 A1
(43) Pub. Date: Oct. 29, 2026

(54) CARBON-EFFICIENT SOFTWARE CODE

(71) Applicant: International Business Machines Corporation, Armonk, NY (US)

(72) Inventors: Chetan RAMAIAH, Bangalore (IN); Logeswaran T. RAJAMANICKAM, Tirupur (IN); Jayateerth KAMATGI, Bengaluru (IN)

(21) Appl. No.: 19/191,283

(22) Filed: Apr. 28, 2025

(51) Int. Cl. G06F 8/35

(52) U.S. Cl. CPC G06F 8/35

(57) ABSTRACT

In some implementations, a device receives a user prompt to generate code for an algorithm. The device generates, for the algorithm using a large language model (LLM), the code based on a software carbon intensity (SCI) score for each of multiple candidate snippets of the code. The device outputs the code.

### BACKGROUND

This disclosure generally relates to sustainable software development and, more specifically, to energy usage of software code.

### SUMMARY

Some aspects described herein relate to a method. The method may include receiving a user prompt to generate code for an algorithm. The method may include generating, for the algorithm using a large language model (LLM), the code based on a software carbon intensity (SCI) score for each of multiple candidate snippets of the code. The method may include outputting the code.

Some aspects described herein relate to a computer system. The computer system may include a processor set, one or more computer-readable storage media, and program instructions stored on the one or more computer-readable storage media to cause the processor set to perform operations. The operations may include generating one or more code snippets using an LLM. The operations may include evaluating the one or more code snippets to identify an algorithm associated with the one or more code snippets. The operations may include determining an overall SCI score for the algorithm. The operations may include selecting a code snippet of the one or more code snippets to output based on the overall SCI score. The operations may include outputting the selected code snippet.

Some aspects described herein relate to a computer program product. The computer program product may include one or more computer-readable storage media and program instructions stored on the one or more computer-readable storage media to perform operations. The operations may include evaluating, by an LLM, an SCI score of a code snippet generated by the LLM, the SCI score being based on energy consumption and grid intensity of an energy source. The operations may include determining, by the LLM, an alternative implementation of the code snippet with a lower SCI score than the SCI score. The operations may include outputting, by the LLM, the alternative implementation of the code snippet with the lower SCI score.

### BRIEF DESCRIPTION OF THE DRAWINGS

FIG. 1 is a diagram of an example computing environment for carbon-efficient software code described herein.

FIG. 2A is a diagram of an example implementation associated with carbon-efficient software code.

FIG. 2B is a diagram of an example computer for carbon-efficient software code.

FIG. 3 is a flowchart of an example process associated with carbon-efficient software code.

FIG. 4 is a flowchart of an example process associated with carbon-efficient software code.

FIG. 5 is a flowchart of an example process associated with carbon-efficient software code.

### DETAILED DESCRIPTION

The following detailed description of example implementations refers to the accompanying drawings. The same reference numbers in different drawings may identify the same or similar elements.

Software development activities have become increasingly energy-intensive due to the growing demand for computation resources, data storage, and network infrastructure. The production and operation of computer systems that execute software can contribute to greenhouse gas emissions, primarily carbon dioxide, which is an environmental concern with respect to environmental sustainability. One of the primary challenges is the lack of awareness and consideration of sustainability parameters during the software development process.

Energy consumption is a large factor in the environmental impact of computer systems. Software development directly consumes energy in various forms, including electricity used by developers'computers, devices, and servers hosting development environments. The impact of energy consumed by software can be significant and is often correlated with the way code is written.

Large Language Models (LLMs) are increasingly being used to generate code, making software development more efficient. However, these models typically do not consider sustainability parameters, such as energy consumption and carbon emissions, when generating code. As a result, the code produced may not be optimized for sustainability, contributing to increased energy consumption and carbon emissions. Current methods for calculating carbon emissions and energy consumption of computer systems are often complex and not easily integrated into the software development process, making it challenging to optimize code for sustainability.

Some implementations described herein provide a computer system that generates code for an algorithm using an LLM-based software carbon intensity (SCI) score for each of multiple candidate snippets of the code. An SCI is a measure of the environmental impact of software executing on a computer system, specifically in terms of its carbon emissions. The SCI is a metric that quantifies the energy consumption and greenhouse gas emissions associated with the development, deployment, and use of software on a computer system.

The SCI score is typically calculated based on factors such as operational emissions, which are the emissions associated with the energy consumption of the computer system, such as the electricity used to power data centers, servers, and other infrastructure. Another factor is embodied emissions, which are associated with the production and disposal of hardware and other equipment used to support the software. This may be a constant value. Another factor may be grid intensity, which is the carbon intensity of the energy source powering the computer system, such as the carbon emissions per kilowatt-hour (kWh) of electricity used.

The SCI score is usually expressed as a rate, such as carbon emissions per functional unit (e.g., per user, per transaction, or per hour of operation). The SCI can be used to compare the environmental impact of different software on computer systems, identify areas for optimization, and track progress toward reducing carbon emissions over time.

A lower SCI score may indicate that software for a computer system is more energy-efficient, uses renewable energy sources, or has optimized its operations to reduce waste. Conversely, a higher SCI score may indicate that software for a computer system has a larger environmental footprint, which could be due to factors such as inefficient coding practices, reliance on carbon-intensive energy sources, or poor data center management.

By measuring and tracking SCI scores, developers and organizations can make informed decisions about how to design, deploy, and operate software on computer systems in a more sustainable and environmentally responsible manner. The resulting software code may be carbon-efficient in that it reduces energy usage and thus reduces the carbon emissions involved with powering software on a computer system.

In an example, the computer system may receive a user prompt to generate code for a specific algorithm and generate the code by selecting one or more snippets of the multiple candidate snippets having a lower SCI score than other snippets, the lowest SCI scores of the multiple candidate snippets, or an SCI score below an SCI threshold. The computer system may also determine an alternative implementation of the code with a lower overall SCI score than an overall SCI score for the code. That is, the computer system may replace one or more of the selected snippets of the code with one or more alternative snippets associated with the alternative implementation. The computer system may also modify the selected snippets, according to the alternative implementation, to achieve a lower overall SCI score than the overall SCI score of the initially generated code.

In this way, the computer system optimizes computational energy consumption and reduces carbon emissions associated with code execution. By integrating SCI scores into the LLM, the computer system minimizes the computational overhead required for code generation and execution. The computer system conserves processing resources, memory resources, network resources, and/or the like by reducing the number of computational cycles required to execute the generated code, and by reducing the memory footprint and data transmission associated with the generated code.

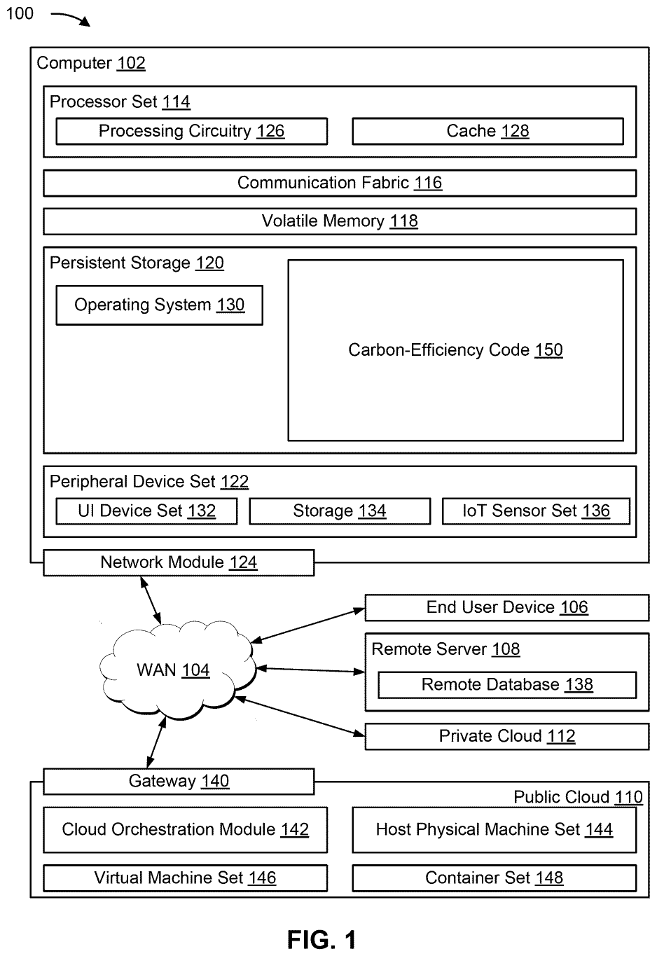

FIG. 1 is a diagram of an example computing environment 100 for carbon-efficient software code described herein.

The computing environment 100 contains an example of an environment for the execution of at least some of the computer code involved in performing the inventive methods, such as carbon-efficiency code 150. In addition to the carbon-efficiency code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the carbon-efficiency code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in carbon-efficiency code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples.

Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the carbon-efficiency code 150 typically includes at least some of the computer code involved in performing one or more operations described herein. The operations may include, for example, receiving a user prompt to generate code for an algorithm and generating, for the algorithm using an LLM, the code based on an SCI score for each of multiple candidate snippets of the code. The operations may include outputting the code.

In some implementations, the operations may include generating one or more code snippets using an LLM and evaluating the one or more code snippets to identify an algorithm associated with the one or more code snippets. The operations may include determining an overall SCI score for the algorithm, selecting a code snippet of the one or more code snippets to output based on the overall SCI score, and outputting the selected code snippet.

In some implementations, the operations may include evaluating an SCI score of a code snippet generated by the LLM, the SCI score being based on energy consumption and grid intensity of an energy source. The operations may include determining an alternative implementation of the code snippet with a lower SCI score than the SCI score and outputting the alternative implementation of the code snippet with the lower SCI score.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

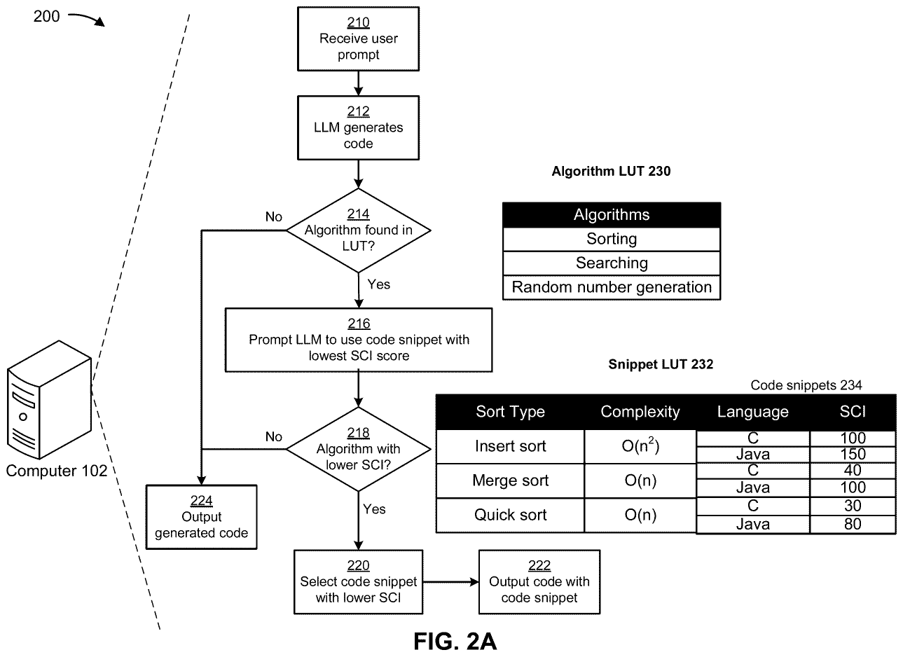

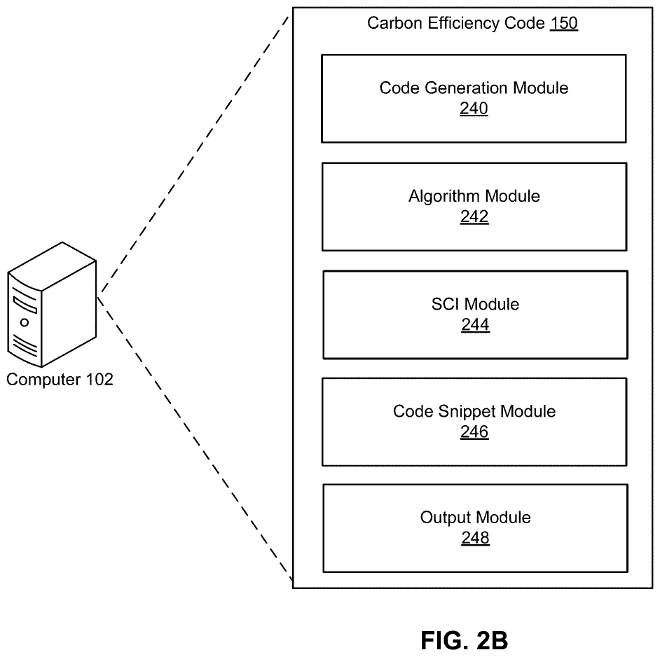

FIG. 2A is a diagram of an example implementation 200 associated with carbon-efficient software code. A computer system (e.g., computer 102) may perform the operations in example implementation 200. FIG. 2B illustrates components of the computer system, such as the carbon efficiency code 150 of FIG. 1 that may perform operations of a computer-implemented method shown in FIG. 2A. The carbon efficiency code 150 may include a code generation module 240, an algorithm module 242, an SCI module 244, a code snippet module 246, and an output module 248. Each module of the carbon efficiency code 150 may operate using the processor set 114, communication fabric 116, volatile memory 118, and persistent storage 120 of computer 102 illustrated in FIG. 1.

Software, including LLMs, may increase energy consumption and carbon emissions associated with software development and execution. Traditional LLMs used for code generation do not consider sustainability parameters, leading to energy-intensive code that contributes to greenhouse gas emissions. In some implementations, the computer system may use an LLM to generate code based on an SCI score for each of multiple candidate snippets of the code. This approach optimizes computational energy consumption and reduces carbon emissions associated with code execution. Selection of code based on SCI scores may also minimize computational overhead required for code generation and execution. By integrating SCI scores into the LLM, the system can conserve processing resources, memory resources, and network resources. This is achieved by reducing the number of computational cycles required to execute the generated code and by reducing the memory footprint and data transmission associated with the generated code. Additionally, the system provides a framework for evaluating the sustainability of code, allowing developers to make informed decisions about their code's environmental impact. The solution offers a novel approach to sustainable software development, enabling developers to create more environmentally friendly software while reducing energy consumption and carbon emissions.

In some implementations, the computer system may be prompted by a user prompt to generate code (e.g., using code generation module 240) for a specific algorithm (e.g., searching, sorting, random number generation), as shown by reference number 210. The computer system may use an LLM to generate the code, as shown by reference number 212. The computer system may identify the algorithm (e.g., using algorithm module 242) from algorithms of different algorithm types in an algorithm look-up table (LUT) 230. The computer system may calculate an SCI score for an algorithm or each code snippet (e.g., using SCI module 244). If the algorithm is found in the LUT 230, as shown by reference number 214, the computer system may select one or more snippets of the multiple candidate snippets of code (e.g., using code snippet module 246) having a lower SCI score than other snippets, the lowest SCI scores of the multiple candidate snippets, or an SCI score below an SCI threshold.

While the computer system uses an algorithm SCI score (based on snippet SCI scores) in example implementation 200, in some implementations, the computer system may calculate an overall SCI score for the code (e.g., for multiple algorithms) for comparison to an overall SCI score threshold for generated code. The computer system may use this overall SCI score comparison as part of the code snippet selection.

A code snippet is a small piece of source code, typically consisting of a few lines or a short block of code, that performs a specific task or function within a larger software program. Code snippets can be written in various programming languages, such as Java® code, C++code, Python code, JavaScript code, or hypertext markup language (HTML)/cascading style sheet (CSS) code. Code snippets can range from simple, trivial examples to more complex, functional blocks of code. Examples of code snippets include a sorting algorithm in Python code, a data encryption function in Java code, a structured query language (SQL) query to retrieve data from a database, a JavaScript function to validate user input, or an HTML/CSS template for a web page layout. By analyzing the SCI scores of individual code snippets, developers can identify areas for optimization and make more informed decisions about how to design and implement their code to reduce the overall carbon footprint of their software.

As shown by reference number 216, the computer system may prompt the LLM to use a code snippet having a lowest SCI score for the algorithm. In implementation 200, the selected algorithm is a sorting algorithm. Snippet LUT 232 includes multiple code snippets 234 for different sort types (more specific algorithm types). The sort types may be an insert sort, a merge sort, or a quick sort. Each sort may be associated with a complexity. As shown by reference number 218, the computer system may select the sort type with a lower SCI, which may be the quick sort. Each sort type may have different code snippets 234 for different languages, such as the C language or the Java language. Each code snippet may have a calculated SCI. In this example, the quick sort has the lowest SCIs for the code snippets.

If the sort type is to be the quick sort, the computer system may select the C language or the Java language for the quick sort. The lower the SCI score, the more sustainability. The C code snippet has an SCI of 30, and the Java code snippet has an SCI of 80. The computer system may select the code snippet with the lower SCI score to be generated by the LLM, as shown by reference number 220, which is the quick sort performed by the C language code snippet. As shown by reference number 222, the computer system may output the selected code snippet (e.g., using output module 248). If the algorithm is not found in the algorithm LUT 230, or the algorithm with the lower SCI is not selected, the computer system may output the generated code (as shown by reference number 224).

In some aspects, the computer system may evaluate the SCI score of a code snippet generated, where the SCI score is based on energy consumption and grid intensity of an energy source. The computer system may determine an alternative implementation of the code snippet with a lower SCI score than the SCI score. Multiple SCI code snippet evaluations may be required in order to determine the lowest SCI score, which may involve rapid code generation processes. In some aspects, the computer system may merge multiple code snippets to create a single code snippet with a lower SCI score.

In some aspects, the computer system may use data structures such as LUTs to store the SCI scores for each code snippet, and may use data movement instructions to merge multiple code snippets into a single code snippet with a lower SCI score. The computer system may use the SCI scores to optimize the code generation process, and use the optimized code to reduce energy consumption and lower carbon emissions. The computer system may use the SCI scores to evaluate the sustainability of the code and use the evaluation results to improve the sustainability of the code.

In some aspects, the SCI score calculation may involve using a standardized approach (SA) methodology, as described by the Green Software Foundation. This methodology provides a framework for estimating the carbon emissions of a software application, taking into account both operational and embodied emissions. For example, the SA methodology may provide guidelines for calculating the SCI score based on energy consumption and grid intensity.

In some aspects, the SCI score calculation may consider both operational emissions and embodied emissions. The operational emissions may be related to the energy consumption of the software, while the embodied emissions may be related to the production and disposal of hardware and other equipment. For example, the SCI score calculation may use a formula that takes into account both operational and embodied emissions to determine the total emissions.

Additionally, or alternatively, the SCI score calculation may assume a constant grid intensity, which may vary depending on the region where the software is deployed. However, as this factor is not directly influenced by the code itself, the grid intensity may be considered a constant in this calculation. For example, the SCI score calculation may use a LUT to determine the grid intensity for a specific region, and may use this value to calculate the SCI score.

In some aspects, the SCI score calculation may assume constant values for embodied emissions and grid intensity. This simplification may allow for a more straightforward comparison of the SCI scores of different code snippets. For example, the SCI score calculation may use a LUT to determine the embodied emissions and grid intensity for a specific code snippet.

In some aspects, SCI is a rate, with carbon emissions per one functional unit R. The equation used to calculate the SCI value of software to be executed on a computer system may be SCI=C per R, where C is the total amount of carbon emissions that result from energy consumed by the computer system executing the software, and R is the functional unit. The code generated by the LLM may be the functional unit. The elements in the SCI equation may scale by the same functional unit of R (e.g., carbon emissions per additional user, API-call, or ML training run). This equation may be expanded to SCI=(O+M) per R, where O represents operational emissions and M represents embodied emissions. Since embodied emissions M cannot be influenced by the code, M is expected to be a constant. Hence SCI∝O per R, which implies that SCI ∝(E*I) per R, where E is the energy consumed and I is region-specific grid intensity. Since the region-specific grid intensity I cannot be influenced by the code, I may be a constant. Hence SCI may be directly proportional to the energy consumed per functional unit (SCI∝E per R).

The LLM may recognize that the lower the SCI score, the lower the energy consumption and carbon emission, thereby integrating sustainability as a factor into code generation. Based on this methodology used to compute a benchmark, and the user prompt, the LLM when generating the code may be aware of SCI scores when identifying a specific algorithm (e.g., sorting, searching) in the code that is generated. The code that is generated will have a lower SCI and thus may have more environmental sustainability. For example, based on the user prompt, the LLM may generate a code to sort input using insertion sort in Java (SCI=150). When SCI scores are available to the LLM, the LLM can generate code where the SCI score is at a minimum. In this example, the lowest SCI is for quick sort in C (SCI=30). Thus, the code can be optimized and generated using a quick sort algorithm. Implementing these optimized snippets in software enhances energy efficiency by reducing electricity usage for performing the same tasks performed by the non-optimal code snippets.

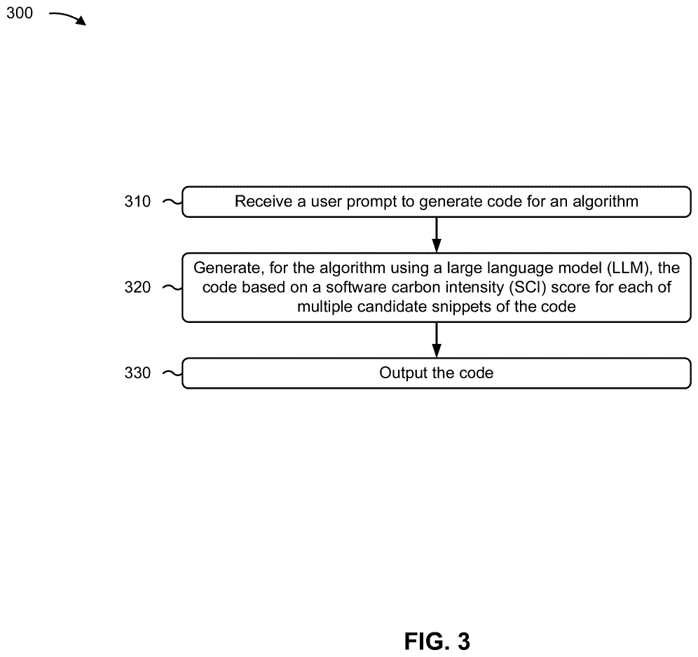

FIG. 3 is a flowchart of an example process 300 associated with carbon-efficient software code. One or more process blocks of FIG. 3 are performed by a computer system (e.g., computer 102) and/or by another device or a group of devices separate from or including the computer system.

As shown in FIG. 3, process 300 includes receiving a user prompt to generate code for an algorithm (block 310). For example, the computer system may receive a user prompt to generate code for an algorithm as described above.

As further shown in FIG. 3, process 300 includes generating, for the algorithm using an LLM, the code based on an SCI score for each of multiple candidate snippets of the code (block 320). For example, the computer system may generate, for the algorithm using an LLM, the code based on an SCI score for each of multiple candidate snippets of the code as described above.

As further shown in FIG. 3, process 300 includes outputting the code (block 330). For example, the computer system may output the code as described above.

Process 300 may include additional aspects, such as any single aspect or any combination of aspects described below and/or in connection with one or more other processes described elsewhere herein.

In a first aspect, the generating of the code comprises selecting one or more snippets of the multiple candidate snippets having a lower SCI score than other snippets, the lowest SCI scores of the multiple candidate snippets, or an SCI score below an SCI threshold.

In a second aspect, alone or in combination with the first aspect, the generating of the code comprises selecting a snippet of the multiple candidate snippets having a lowest SCI score for the algorithm.

In a third aspect, alone or in combination with one or more of the first and second aspects, process 300 includes determining an alternative implementation of the code with a lower overall SCI score than an overall SCI score for the code, and replacing one or more snippets of the code with one or more alternative snippets associated with the alternative implementation.

In a fourth aspect, alone or in combination with one or more of the first through third aspects, process 300 includes evaluating the code for sustainability parameters by calculating an overall SCI score for the code based on energy consumed by the code and a grid intensity of an energy source, and relatively comparing the overall SCI score. This may include comparing the SCI scores of the multiple candidate snippets to the overall SCI score.

In a fifth aspect, alone or in combination with one or more of the first through fourth aspects, the calculating of the overall SCI score comprises using a lookup table to determine an SCI score for each snippet of an implementation of the code.

In a sixth aspect, alone or in combination with one or more of the first through fifth aspects, the LLM is trained on a dataset of code examples with associated SCI scores.

In a seventh aspect, alone or in combination with one or more of the first through sixth aspects, the generating of the code comprises displaying multiple alternative implementations of the code with associated SCI scores, and receiving user input for a selected implementation.

In an eighth aspect, alone or in combination with one or more of the first through seventh aspects, process 300 includes evaluating the code for sustainability parameters based on operational emissions and embodied emissions associated with the code.

In a ninth aspect, alone or in combination with one or more of the first through eighth aspects, the embodied emissions are represented by a constant value.

In a tenth aspect, alone or in combination with one or more of the first through ninth aspects, process 300 includes calculating energy consumption of the code using a lookup table of energy consumption values for programming languages and implementations.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

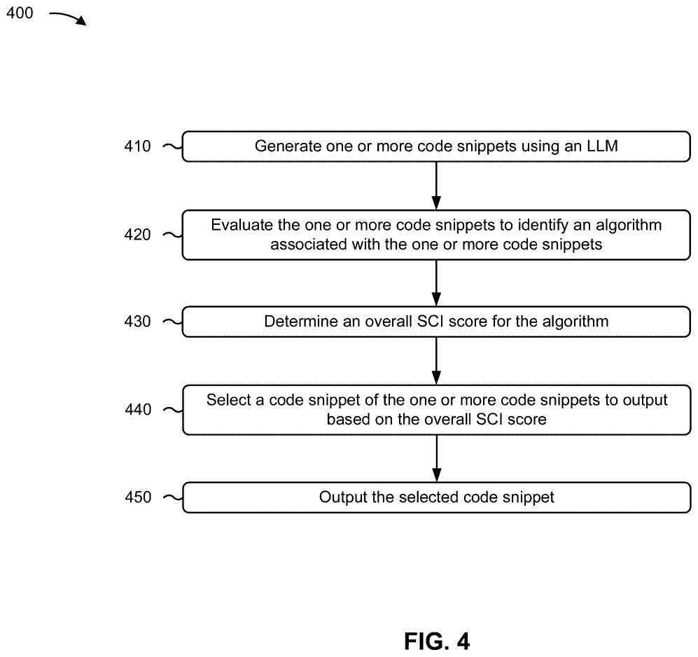

FIG. 4 is a flowchart of an example process 400 associated with carbon-efficient software code. One or more process blocks of FIG. 4 are performed by a computer system (e.g., computer 102) and/or by another device or a group of devices separate from or including the computer system.

As shown in FIG. 4, process 400 includes generating one or more code snippets using an LLM (block 410). For example, the computer system may generate one or more code snippets using an LLM as described above.

As further shown in FIG. 4, process 400 includes evaluating the one or more code snippets to identify an algorithm associated with the one or more code snippets (block 420). For example, the computer system may evaluate the one or more code snippets to identify an algorithm associated with the one or more code snippets as described above.

As further shown in FIG. 4, process 400 includes determining an overall SCI score for the algorithm (block 430). For example, the computer system may determine an overall SCI score for the algorithm as described above.

As further shown in FIG. 4, process 400 includes selecting a code snippet of the one or more code snippets to output based on the overall SCI score (block 440). For example, the computer system may select a code snippet of the one or more code snippets to output based on the overall SCI score as described above.

As further shown in FIG. 4, process 400 includes outputting the selected code snippet (block 450). For example, the computer system may output the selected code snippet as described above.

Process 400 may include additional aspects, such as any single aspect or any combination of aspects described below and/or in connection with one or more other processes described elsewhere herein.

In a first aspect, the determining of the overall SCI score includes determining the overall SCI score based on energy to be consumed by each of the one or more code snippets and a grid intensity of an energy source powering the one or more code snippets.

In a second aspect, alone or in combination with the first aspect, process 400 comprises comparing one or more SCI scores of the one or more code snippets to the overall SCI score to determine which code snippet has a lowest SCI score.

In a third aspect, alone or in combination with one or more of the first and second aspects, the overall SCI score is based on operational emissions and a constant representing embodied emissions.

In a fourth aspect, alone or in combination with one or more of the first through third aspects, the overall SCI score is based on a number of functional units that are predicted to use the code snippet.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

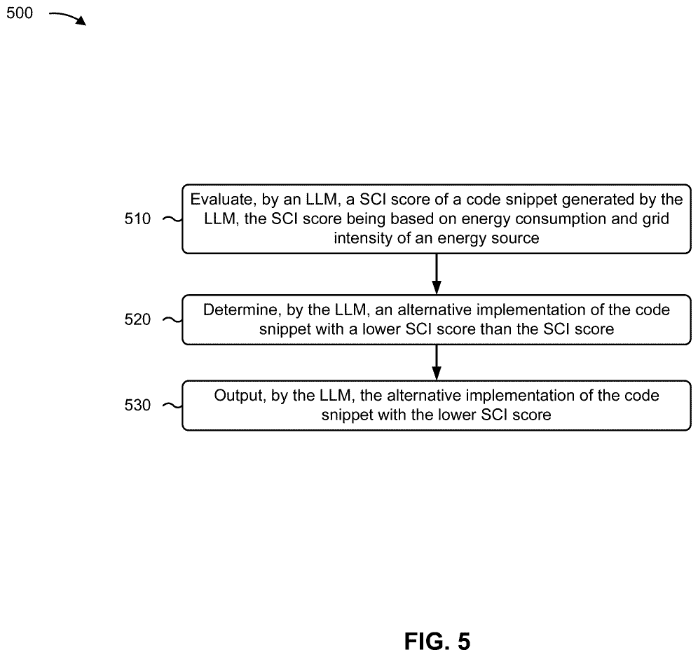

FIG. 5 is a flowchart of an example process 500 associated with carbon-efficient software code. One or more process blocks of FIG. 5 are performed by a computer system (e.g., computer 102) and/or by another device or a group of devices separate from or including the computer system.

As shown in FIG. 5, process 500 includes evaluating an SCI score of a code snippet generated by the LLM, the SCI score being based on energy consumption and grid intensity of an energy source (block 510). For example, the computer system may evaluate an SCI score of a code snippet generated by the LLM, the SCI score being based on energy consumption and grid intensity of an energy source as described above.

As further shown in FIG. 5, process 500 includes determining an alternative implementation of the code snippet with a lower SCI score than the SCI score (block 520). For example, the computer system may determine an alternative implementation of the code snippet with a lower SCI score than the SCI score as described above.

As further shown in FIG. 5, process 500 includes outputting the alternative implementation of the code snippet with the lower SCI score (block 530). For example, the computer system may output the alternative implementation of the code snippet with the lower SCI score as described above.

Process 500 may include additional aspects, such as any single aspect or any combination of aspects described below and/or in connection with one or more other processes described elsewhere herein.

In a first aspect, process 500 comprises calculating the SCI score for the alternative implementation of the code snippet based on operational and embodied emissions per functional unit, comparing the SCI score of the alternative implementation of the code snippet with an overall SCI score for an associated algorithm, selecting the alternative implementation of the code snippet for output based on a result of the comparison, and outputting the alternative implementation.

In a second aspect, alone or in combination with the first aspect, the LLM is associated with a lookup table that includes SCI scores for different implementations of the code snippet in multiple programming languages.

In a third aspect, alone or in combination with one or more of the first and second aspects, process 500 comprises determining, using the LLM, one or more existing codebases to refactor to reduce SCI scores.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a user prompt to generate code for an algorithm;
generating, for the algorithm using a large language model (LLM), the code based on a software carbon intensity (SCI) score for each of multiple candidate snippets of the code; and
outputting the code.

2. The method of claim 1, wherein the generating of the code comprises selecting one or more snippets of the multiple candidate snippets having a lower SCI score than other snippets of the multiple candidate snippets, lowest SCI scores of the multiple candidate snippets, or an SCI score below an SCI threshold.

3. The method of claim 1, wherein the generating of the code comprises selecting a snippet of the multiple candidate snippets having a lowest SCI score for the algorithm.

4. The method of claim 1, further comprising:
determining an alternative implementation of the code with a lower overall SCI score than an overall SCI score for the code; and
replacing one or more snippets of the code with one or more alternative snippets associated with the alternative implementation.

5. The method of claim 1, further comprising evaluating the code for sustainability parameters by:
calculating an overall SCI score for the code based on energy consumed by the code and a grid intensity of an energy source; and
comparing the SCI scores of the multiple candidate snippets to the overall SCI score.

6. The method of claim 5, wherein the calculating of the overall SCI score comprises using a lookup table to determine an SCI score for each snippet of an implementation of the code.

7. The method of claim 1, wherein the LLM is trained on a dataset of code examples with associated SCI scores.

8. The method of claim 1, wherein the generating of the code comprises:
displaying multiple alternative implementations of the code with associated SCI scores; and
receiving user input for a selected implementation.

9. The method of claim 1, further comprising:
evaluating the code for sustainability parameters based on operational emissions and embodied emissions associated with the code.

10. The method of claim 9, wherein the embodied emissions are represented by a constant value.

11. The method of claim 1, further comprising calculating energy consumption of the code using a lookup table of energy consumption values for programming languages and implementations.

12. A computer system comprising:
a processor set;
one or more computer-readable storage media; and
program instructions stored on the one or more computer-readable storage media to cause the processor set to perform operations, comprising:
generating one or more code snippets using a large language model (LLM);
evaluating the one or more code snippets to identify an algorithm associated with the one or more code snippets;
determining an overall software carbon intensity (SCI) score for the algorithm;
selecting a code snippet of the one or more code snippets to output based on the overall SCI score; and
outputting the selected code snippet.

13. The computer system of claim 12, wherein the determining of the overall SCI score includes determining the overall SCI score based on energy to be consumed by each of the one or more code snippets and a grid intensity of an energy source powering the one or more code snippets.

14. The computer system of claim 12, wherein the operations comprise:
comparing one or more SCI scores of the one or more code snippets to the overall SCI score to determine which code snippet has a lowest SCI score.

15. The computer system of claim 12, wherein the overall SCI score is based on operational emissions and a constant representing embodied emissions.

16. The computer system of claim 12, wherein the overall SCI score is based on a number of functional units that are predicted to use the code snippet.

17. A computer program product comprising:
one or more computer-readable storage media; and
program instructions stored on the one or more computer-readable storage media to perform operations comprising:
evaluating, by a large language model (LLM), a software carbon intensity (SCI) score of a code snippet generated by the LLM, the SCI score being based on energy consumption and grid intensity of an energy source;
determining, by the LLM, an alternative implementation of the code snippet with a lower SCI score than the SCI score; and
outputting, by the LLM, the alternative implementation of the code snippet with the lower SCI score.

18. The computer program product of claim 17, wherein the operations further comprise:
calculating the SCI score for the alternative implementation of the code snippet based on operational and embodied emissions per functional unit;
comparing the SCI score of the alternative implementation of the code snippet with an overall SCI score for an associated algorithm;
selecting the alternative implementation of the code snippet for output based on a result of the comparison; and
outputting the alternative implementation.

19. The computer program product of claim 17, wherein the LLM is associated with a lookup table that includes SCI scores for different implementations of the code snippet in multiple programming languages.

20. The computer program product of claim 17, wherein the operations further comprise:
determining, using the LLM, one or more existing codebases to refactor to reduce SCI scores.
